(19) United States
(12) Patent Application Publication
(10) Pub. No.: US 2004/0114042 A1
(43) Pub. Date: Jun. 17, 2004

(54) Systems and methods for annotating digital images

(75) Inventors: Michael A. Paolini, Austin, TX (US); Cornell G. Wright JR., Austin, TX (US)

Correspondence Address: Barry S. Newberger, 5400 Renaissance Tower, 1201 Elm Street, Dallas, TX, 75270, US

(73) Assignee: International Business Machines Corporation, Armonk, NY

(21) Appl. No.: 10/317,988

(22) Filed: Dec. 12, 2002

(51) Int. Cl. H04N 5/225

(52) U.S. Cl. 348/207.99

(57) ABSTRACT

Apparatus and methods are provided for annotating digital images with information meaningful to a viewer. Data related to physical parameters associated with the digital image, such as, a geographic location (which may be a GPS latitude and longitude) and optionally, other parameters, are used to associate the image with information meaningful to a viewer. These parameters may be used in conjunction with a database that associates physical position information with such information.

### TECHNICAL FIELD

The present invention is related, in general, to digital photography and videography, and in particular, to data processing systems and methods for automatically annotating digital photographic and videographic images, and more particularly with annotations derived from one or more physical parameters associated with the subject matter of the image and the photographic or videographic system.

### BACKGROUND INFORMATION

Advances in digital electronics has led to the development of digital imaging systems that are competitive, in both quality and cost, with conventional silver halide photography. These systems derive their advances and capabilities from embedded-system processing power, as well as the reduction in costs and increased availability of non-volatile storage mechanisms. The latter may include both “silicon” based memory, such as flash memory, or electro mechanical systems such as miniaturized disk drives. As a consequence, digital imaging systems capable of producing good quality photographic images are becoming widely available.

Additionally, similar advances in digital technology have made receiver systems for acquiring the transmission from the constellation of satellites that implement the satellite navigation system commonly referred to as the global positioning system (GPS). GPS receivers yielding quite acceptable two-dimensional position information are widely available in the consumer market.

As a consequence, digital photography systems have been integrated with commercially available GPS receivers to record position information, that is latitude and longitude, along with the timestamp into the digital photographs. Additionally, conventional digital cameras allow for audio memos to be associated with the digital photographs as well. However, the latter require a separate playback system in order to identify the subject matter of the photograph, or other audio information recorded therewith, and the latitude and longitude data is, when displayed with the digital image, is not immediately recognizable or otherwise readily associated with features meaningful to a viewer. Consequently, there is a need in the art for systems and methods for automatically annotating digital photographs whereby information that is immediately meaningful to a human user is automatically associated with the photograph, and selectively available for presentation in conjunction with the display of the photograph.

### SUMMARY OF THE INVENTION

The aforementioned needs are addressed by the present invention. In one embodiment, a method for annotating digital images may be performed. The method includes acquiring data representing a position corresponding to a locus of the digital image and correlating descriptive information with the data representing the position. The method also associates the descriptive information with a digital image file containing the digital image, whereby the descriptive annotation may be displayed with the image.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates, in block diagram form, an apparatus for annotating a digital image in accordance with the present inventive principles;

FIG. 2 illustrates, in block diagram form, an alternative embodiment of an apparatus for annotating digital images in accordance with the present invention;

FIG. 3 illustrates, in flowchart form, a methodology for annotating digital images in accordance with the principles of the present invention;

FIG. 4 illustrates, in flow chart form, a methodology for annotating digital images in accordance with an embodiment incorporating the present inventive principles;

FIG. 5 illustrates, in flow chart form, a methodology for annotating digital images in accordance with an alternative embodiment incorporating the present inventive principles; and

FIG. 6 illustrates, in block diagram form, a data processing system which may be used in conjunction with the embodiment of the present invention illustrated in FIGS. 1 and 2.

### DETAILED DESCRIPTION

Apparatus and methods are described for annotating digital images with descriptive information that is meaningful to a viewer. Data related to physical parameters associated with the digital image, such as, a geographic location (which may be a GPS latitude and longitude), and parameters associated with the imaging system itself, such as lens focal length, tilt angle and direction are used to associate the image with information meaningful to a viewer. Note that alternative embodiments incorporating the present inventive principles may implement a subset of these parameters, which are exemplary, and not exhaustive. These parameters may be used in conjunction with a database that associates physical position information with the names of landmarks, or other human readable and meaningful information corresponding thereto. For a particular image, the associated physical parameters may be used to correlate the image with information in the database, thereby providing an annotation that is recognizable or meaningful to a typical viewer.

In the following description, numerous specific details are set forth to provide a thorough understanding of the present invention. For example, specific file formats may be referred to, as in other cases particular protocols may be referenced, however it would be recognized by those of ordinary skill in the art that the present invention may be practiced without such specific details, and, in other instances, well-known circuits have been shown in block diagram form in order not to obscure the present invention in unnecessary detail. Refer now to the drawings wherein depicted elements are not necessarily shown to scale and where and like or similar elements are designated by the same reference numeral through the several views.

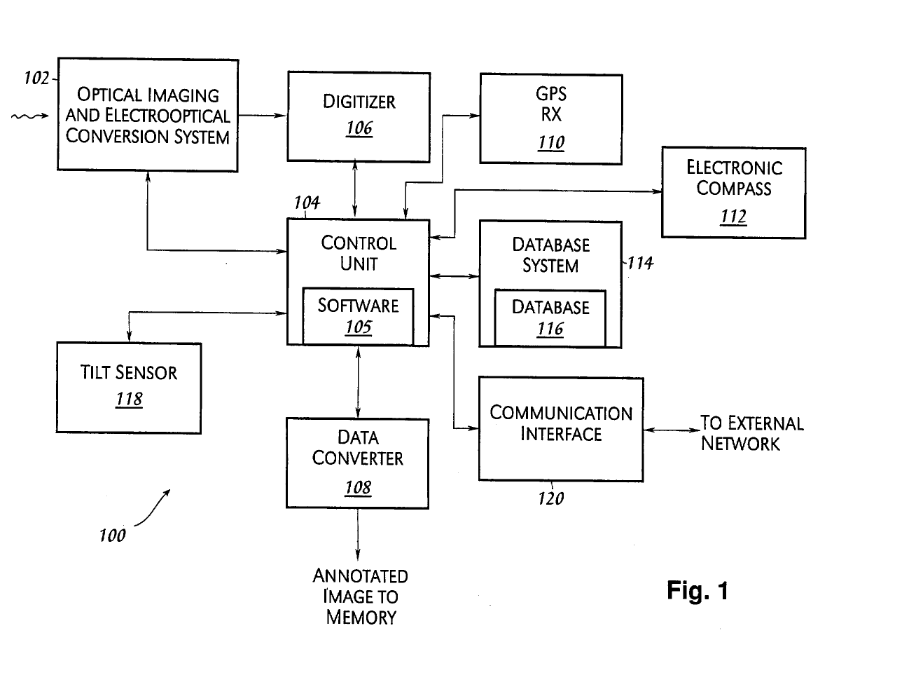

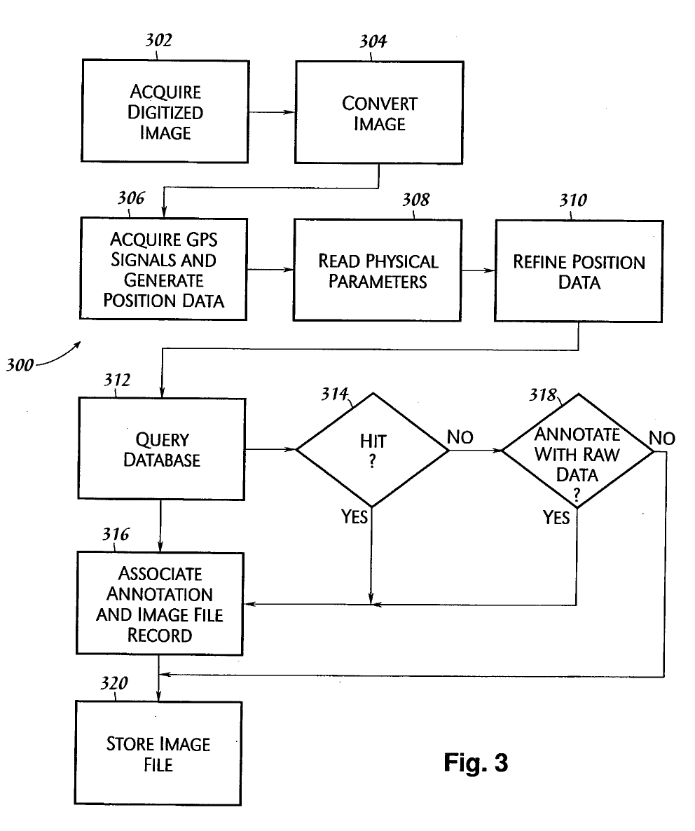

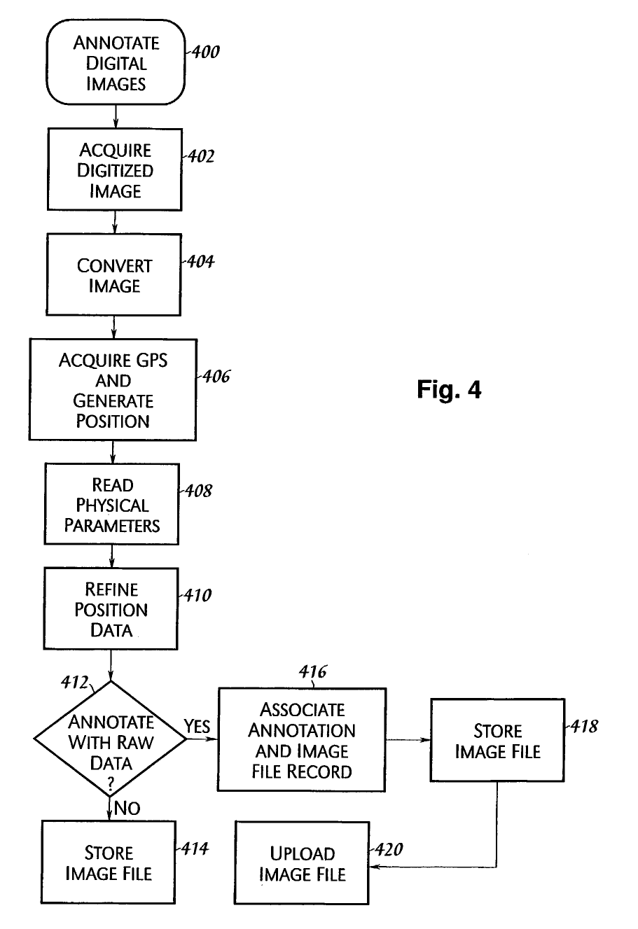

Referring now to FIG. 1, there is illustrated therein a photo-recording system 100 in accordance with the principles of the present invention. Photo-recording system 100 may be used to generate digital photographs, or alternatively, digital videographs. An optical imaging system and electro optical conversion system 102 receives light from the object to be photographed or videographed and converted to electrical signals. The optical imaging system may be a conventional lens system which focuses light onto an optical transducer, such as a charge-coupled device (CCD), which generates an electrical signal in response to the light impinging thereon. Additionally, the operation of the optical imaging and electro optical conversion system may be coordinated by a control unit 104 which, may be a general purpose microprocessor or microcontroller. Control unit 104 may operate in combination with software 105, a portion of which may perform processes of the present invention described further in conjunction with FIGS. 3 and 4. Control unit 104 in conjunction with the optical imaging system, may for example, form an automated exposure and focus control, as would be recognized by those of ordinary skill in the art. Automated focus and exposure features may be found in conventional digital cameras. Digitizer 106 is coupled to the electro optical conversion system and digitizes the electrical signal output by each pixel of the system. Digitizer 106 may also operate under the control of control unit 104. The digital signal is converted by data converter 108 into a graphical file format. Exemplary file formats that may be used in embodiments of the present invention include the Graphics Interchange Format (GIF) and Joint Photographic Experts Group (JPEG) formats. Similarly, videographic images may be converted to video data files in accordance with the Moving Picture Experts Group (MPEG) file format.

Additionally, photo-recording system 100 includes a Global Positioning System (GPS) receiver (RX) 110, electronic compass 112 and database system 114. Database system 114 includes database 116. Additionally, tilt sensor 118 may also be included. In an embodiment of the present invention, electronic compass 112 may be implemented using a commercially available magneto-resistive magnetic field sensor such as the KMZ52 device from Philips Semiconductor, Sunnyvale, California. Tilt sensor 118, in an embodiment of the present invention, may use an electrolytic tilt sensor. Such tilt sensors are commercially available from, for example, Nanotron, Inc., Tempe, Ariz.

GPS receiver 110 provides geographic position information, typically in the form of a latitude and longitude. Such position information may be correlated with geographic data in database 116. In an embodiment of the present invention, database 116 may be populated, via database system 114 by downloading geographic data via communication interface 120 coupled to an external network. Communication interface 120 may be an interface in accordance with a standardized protocol, such as IEEE 1394 (IEEE 1394 is commonly referred to as “FireWire™.” FireWire™ is a trademark of Apple Computer, Inc., Cupertino, Calif. Note that the external network may be connected to a data processing system, such as a conventional personal computer or work station which may further interface with a multiplicity of data sources suitable for populating the database via, for example, the Internet. One such database that may be used in conjunction with the present invention is the United States Census Bureau's database. (Tiger® also is an acronym for the Topologically Integrated Geographic Encoding and Referencing System. The Tiger® home page may be found at http://www.census.gov/geo/www/tiger.) In particular, database 116 may include data that is meaningful to a typical human viewer associated with particular geographic coordinates. For example, notable landmarks, such as the Statue of Liberty or the Washington Monument may be associated with the latitude and longitude thereof. (Such information may for descriptive simplicity be referred to as viewer recognizable information.) In operation, as will be discussed further hereinbelow, by correlating a current position of the photo-recording device incorporating the present inventive principles, as determined by the GPS, with the information in database 116, viewer recognizable information associated with the present position may be used to generate an annotation for the digital image.

This information may be provided via control unit 104, to data converter 108. In this way, viewer recognizable information may be associated with the digital data representing the object being photographed or videographed. For example, the viewer recognizable information may be in an exemplary embodiment, superimposed over the image, by rendering the text within the graphical area of the digital photograph or videograph. Alternatively, the data may be imbedded with the image, and read by the video display software when the image is being displayed. For example, the annotation facility of Scalable Vector Graphics (SVG) may be used in an embodiment of the present invention. Scalable Vector Graphics (SVG) is a language for describing two-dimensional vector and mixed vector/raster graphics in XML. That is, SVG is a dialect of XML. The specification for SVG is promulgated by the W3C and may be found in http://www.w3.org/TR/SVG/. In such an embodiment, the image is represented as an SVG document, and the annotations are stored in a separate file. The XML Pointer Language (Xpointer) may be used to describe where an annotation is to be attached to the SVG document. The Xpointer scheme specification, promulgated by W3C may be found at http://www.w3.org/TR/xptr-xpointer/. The Xpointer scheme is used with the Xpointer Framework (XPtrFrame). The specification for XPtrFrame is also promulgated by the W3C, and may be found at http://www.w3.org/TR/xptr-framework/. In another exemplary embodiment incorporating the present inventive principles, data may be imbedded within an image in a tag, similar to an MP 3ID tag or a JPEG image description tag.

Additionally, information from the tilt sensor 118 and electronic compass 113 may be used to refine the GPS position information to further determine the specific features in the field of view of the digital recording device.

For example, an angle of tilt of the image recording device as determined by tilt sensor 118, and a heading, as determined by electronic compass 113, may be combined with the parameters of the imaging system such as the focal distance, focal length and size of the electro-optical sensor, which define a field of view, to derive a refined position value for an object in the field of view of the imaging device using standard trigonometric relationships. Database 116 may include declination data to correct for the difference between true and magnetic headings as determined using compass 112. Alternatively, declination values for a particular location may be calculated using a model of the earth's geomagnetic field. One such publicly available model is the International Geomagnetic Reference Field (IGRF) which is available from the United States National Geophysical Data Center (NGDC). Another is the World Magnetic Model (WMM) promulgated by the United States Department of Defense (DOD) and is available therefrom or from the NGDC, including source code in either C or FORTRAN. Program instructions for calculating declination values may be included, for example, in software 105 for central unit 104. Additionally, a user manipulable input may be provided whereby a particular feature in the field of view may be selected, to further refine the position determination, and concomitantly, the annotation.

Note that, in alternative embodiments in accordance with the present inventive principles, GPS receiver 110 may be a free standing GPS device, or alternatively, may be GPS receiver circuitry integrated into the photo-recording system. Similarly, control unit 104, as previously noted, may be a microprocessor or microcontroller or, alternatively, may be incorporated, along with GPS receiver circuitry as an application specific integrated circuit (ASIC). Likewise, one or more of electronic compass 112 and tilt sensor 118, digitizer 106 and data converter 108 and communication interface 120 may be incorporated in such an ASIC. It would be appreciated by those of ordinary skill in the art that such alternative embodiments, and other configurational variants thereof incorporating the present inventive principles would fall within the spirit and scope of the present invention.

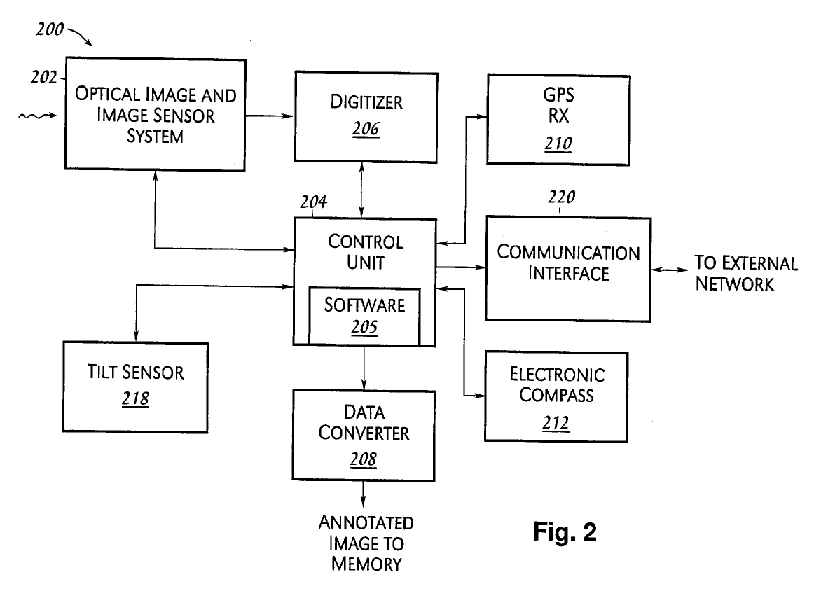

Refer now to FIG. 2 which illustrates an alternative digital imaging system 200 incorporating the present inventive principles. System 200 is similar to imaging system 100 depicted in FIG. 1. However, system 200 lacks an “on-board” database. Thus, in system 200, optical imaging and sensor system 202, control unit 204, software 205, digitizer 206, data converter 208, GPS receiver 210, electronic compass 212, tilt sensor 218 and communication interface 220 perform the corresponding functions as optical imaging and electro optical conversion system 102, control unit 104, software 105, digitizer 106, data converter 108, GPS receiver 110, electronic compass 112, tilt sensor 118 and communication interface 120 in system 100, FIG. 1. In system 200, the annotation incorporated in the digital image may constitute “raw” data including the position of the digital imaging device obtained from GPS receiver 210, or a refined position derived therefrom using the physical parameters associated with the imaging system, as described above. The digital images, including the annotation information in raw data form, may be downloaded to a data processing system, such as a personal computer or work station, via communication interface 220. The raw data incorporated in the annotation may then be used to provide a viewer recognizable connotation. Note too that the raw data, may, in an alternative embodiment, include the physical parameters associated with the imaging system, as well as any such parameters derived from a user selected feature in the field of view. In such an embodiment, the computations to derive a refined position value may be performed in the data processing system receiving the downloaded images. A data processing system which may be used in the present invention will be described below.

Similarly to system 100 of FIG. 1, the components of system 200 may be configured in alternative embodiments incorporating the present inventive principles. Such alternative embodiments would be recognized by those of ordinary skill in the art to fall within the spirit and scope of the present invention.

Refer now to FIG. 3 which illustrates, in flowchart form, a methodology for annotating digital images in accordance with the present invention. At least a portion of the methodology may be embodied in software, such as software 105, FIG. 1 and 205, FIG. 2. The flowcharts provided herein are not necessarily indicative of the serialization of operations being performed. Steps disclosed within these flowcharts may be performed in parallel. The flowcharts are indicative of those considerations that may be performed to produce operations available to annotate digital images such as digital photographs and videographs. It is further noted that the order presented is illustrative and does not necessarily imply that the steps must be performed in the order shown.

In step 302, the digitized image is acquired. Step 302 may be performed by the imaging system, electro optical converter and digitizer as may be typically employed in digital photographic or videographic equipment. In step 304, the raw image is converted to a graphics file, for example a JPEG or MPEG file. GPS signals are acquired in step 306, and the position corresponding to the photographic equipment and commonly located GPS receiver are generated. Note that step 306 may be performed by a conventional GPS receiving device, which as previously noted, may be a free standing GPS receiver, or alternatively, an embedded GPS receiver implementation may be used. Single-chip GPS solutions that may be used in conjunction with the present invention include the MG-4000 and MG-4100 GPS chips by Motorola, Inc., Schaumburg, Ill. In step 308, physical parameters associated with the recording device, for example, a compass heading, tilt angle and optical settings of the device are determined and, in step 310, the position data are refined in accordance with standard trigonometric relationships. In this way, for example, a point position associated with the GPS may be augmented to provide, for example, a coordinate of an object in the field of view or, define a range of coordinates bounding the subject matter being imaged. Concomitantly, the viewer recognizable annotation may be suitably refined.

The position data may be correlated with descriptive information and associated with the corresponding image (steps 312-316). In step 312, the database of geographic coordinates and viewer recognizable features and the corresponding viewer recognizable descriptive information is accessed. Such a database may be embodied in an apparatus in accordance with the present inventive principles as discussed hereinabove in conjunction with FIG. 1 illustrating database 116. If there is a hit in the database, step 314, then in step 316, the viewer recognizable descriptive information is associated, as an annotation with the image file record of the photographed or videographed subject matter. If, however, there is no hit in the database associated with the particular geographic location, then in step 318, a determination is made if the image is annotated with the raw position data, and physical parameters. The determination may be made in response to a user selection. If the image is to be annotated with the raw data, methodology 300 returns to step 316 and annotates the image file record accordingly. Otherwise, step 316 is bypassed.

The image file is stored in step 320. The storage of image files may be in a nonvolatile storage medium, for example, a flash memory as are typically used in digital imaging devices, or in magnetic storage medium, such as an IBM Microdrive, a product of IBM Corporation, Armonk, N.Y. A particular photo-recording system such as a digital video camera or digital movie camera may have facilities for incorporating a multiplicity of types of removable nonvolatile storage media. Recording devices in accordance with the present are inventive principles not limited to a particular storage medium.

Referring now to FIG. 4, there is illustrated therein, also in flowchart form, an alternative methodology 400 for annotating digital images in accordance with the present inventive principles. Methodology 400 may be used in conjunction with a personal computer, work station or similar data processing system for annotating images that are uploaded from the digital camera. Methodology 400 may also be used with an embodiment of the present invention in accordance with recording device 200, FIG. 2, which does not include an integrated database. At least a portion of methodology also may be embodied, for example, in software 205, FIG. 2. In methodology 400, steps 402-410 may be performed analogously to corresponding steps 302-310 in methodology 300 illustrated in FIG. 3 and previously discussed in conjunction with methodology 300.

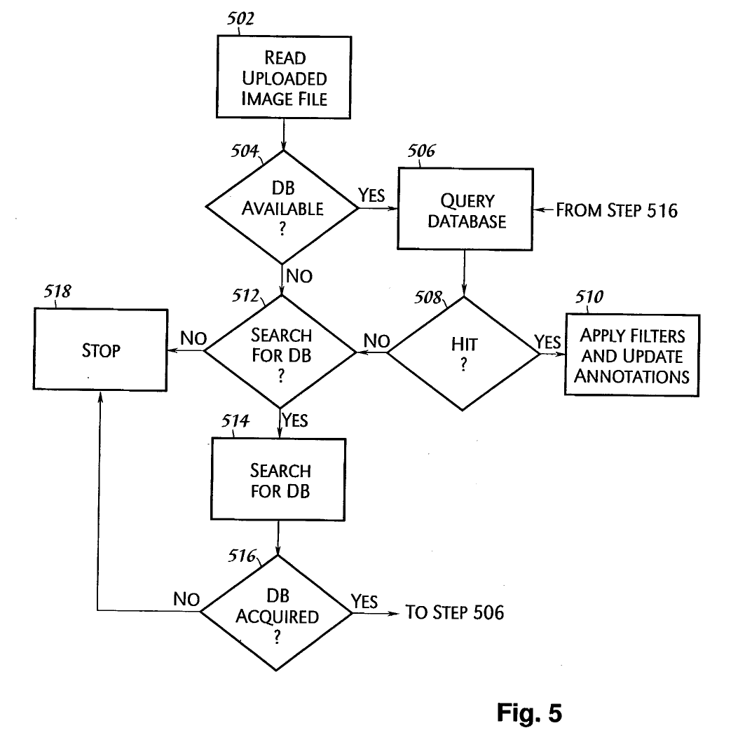

In step 412, it is determined if the image is to be annotated with the raw data, that is, for example, the coordinates of the location and physical parameters associated with the imaging system. If not, the image file is stored in step 414. If however, the image is to be annotated with raw data, in step 416, the annotation is associated with the image file record, and in step 418, the image file is stored. Note that the determination in step 412 may be made in response to user input, whereby a user may selectably annotate with the raw data for post processing, as discussed further in conjunction with FIG. 5. Accordingly, image files to be post processed may be uploaded in step 420.

In FIG. 5, there is illustrated methodology 500 for further annotating digital images with viewer recognizable information in accordance with an alternative embodiment incorporating the present inventive principles. Methodology 500 may be used in conjunction with a data processing system such as a personal computer, work station, personal digital assistant (PDA), notebook computer or similar device. It would be appreciated by those of ordinary skill in the art that the present inventive principles may be practiced in a multiplicity of data processing systems, and that such systems would fall within the spirit and scope of the present invention.

In step 502, the position data incorporated in the image file in accordance with, for example, methodology 400, FIG. 4, is read. If, in step 504 database (DB) is locally available, the database is queried in step 506. The database may be queried to determine if the location associated with the graphic image being annotated with viewer recognizable information is contained in the database, step 508.

Position data read in step 502 may be correlated with descriptive information which may be used to annotate the corresponding image in conjunction with steps 508 and 510. If the location hits in the database in step 508, then the viewer recognizable information associated with the location may be retrieved, and the annotation associated with the graphical image updated with that information, step 510. In other words, the raw data may be replaced with the corresponding information obtained from the database. Additionally, in step 510, filters which may in an embodiment of the present invention, be user selectable, may be applied to the viewer recognizable data. Filters may, for example, be used to format the display of the information such as color, font, etc. One mechanism for specifying filters, which may be used in conjunction with information stored in an eXtensible Markup Language (XML) format is the eXtensible Stylesheet Language (XSL). In particular, the filter may be implemented using XSL Transformations (XSLT) which is a language for transferring XML documents in other XML documents. The specification for XSLT is promulgated by the W3C and can be found at http://www.w3.org/TR/xslt. In particular, XSLT may be used to transform an XML document into Hypertext Markup Language (HTML) document. This may be used with Cascading Style Sheets (CSS) to modify the appearance of the annotation by, for example, using XSLT to transform an XSL document to an HTML document with CSS style sheets. As would be appreciated by those of ordinary skill in the arts, CSS style sheets attach style properties to elements of the HTML document, to specify the presentation style of the document (e.g. fonts, colors, etc.). The specification for CSS style sheets is promulgated by the W3C and is currently CSS level 2 (CSS2). (The specification may be found at http://www.w3.org/TR/REC-CSS2.).

If, however, the location, as expressed in the annotated raw data uploaded with the image, does not hit in the database, it is determined in step 512, if a search for a database of geographic locations is to be made. The decision in step 512 may be determined in response to user input. Likewise, returning the step 504, if a local database is not available, a search for a database which may be used may also be made. Again, the decision may be made in response to user input.

If a search for a database is selected, a search is initiated in step 514. One resource for such information is the World Wide Web (WWW) or simply the “web.” The search may include a search based on the location associated with the image to be annotated, as specified by the GPS coordinates, for example. A mechanism for exposing a database which may be used in conjunction with the present inventive principles is the Universal Description, Discovery & Integration (UDDI) protocol. The UDDI protocol provides a mechanism for exposing web services. (The UDDI specification, currently in version 3 is available at http://uddi.org/pubs/uddi-v3.00-published20020719.htm. The UDDI specification is incorporated herein by reference.) The UDDI may be used to expose a database of location-based human recognizable information, using location-based indexing and lookup. If a database having location-based information for the particular location is acquired, step 516, methodology 500 proceeds to step 506 and queries the database as previously described. Otherwise, the process terminates in step 518. Likewise, if a user elects not to do a search for a database, in step 512, process 500 also terminates step 518.

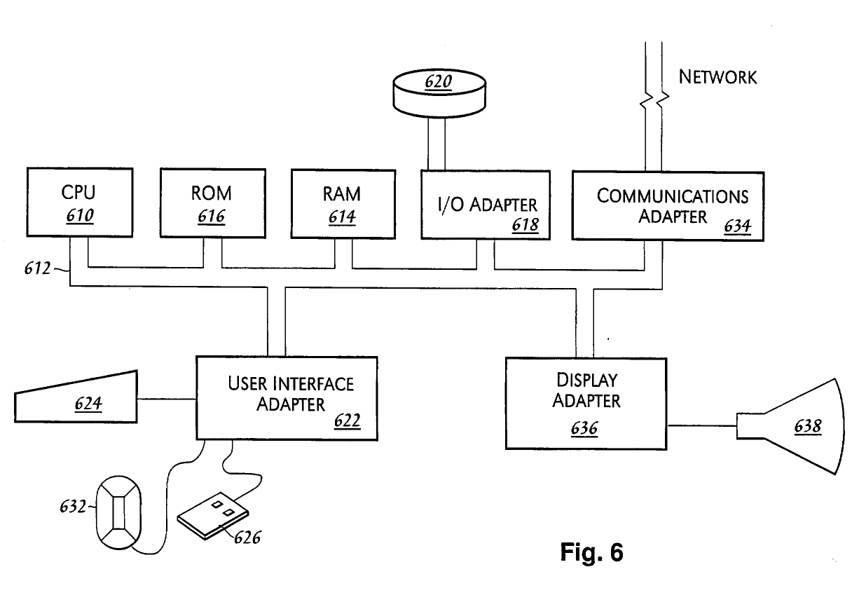

A data processing system which may be used in conjunction with the methodology of FIG. 5, is illustrated in FIG. 6. FIG. 6 illustrates an exemplary hardware configuration of data processing system 600 in accordance with the subject invention. The system in conjunction with methodology 500, may be used with the imaging system embodiments of FIGS. 1 and 2 as an alternative way to annotate the images. Data processing system 600 includes central processing unit (CPU) 610, such as a conventional microprocessor, and a number of other units interconnected via system bus 612. Data processing system 600 also includes random access memory (RAM) 614, read only memory (ROM) 616 and input/output (I/O) adapter 618 for connecting peripheral devices such as disk units 620 to bus 612, user interface adapter 622 for connecting keyboard 624, mouse 626, trackball 632 and/or other user interface devices such as a touch screen device (not shown) to bus 612. System 600 also includes communication adapter 634 for connecting data processing system 600 to a data processing network, enabling the system to communicate with other systems, and display adapter 636 for connecting bus 612 to display device 638. CPU 610 may include other circuitry not shown herein, which will include circuitry commonly found within a microprocessor, e.g. execution units, bus interface units, arithmetic logic units, etc. CPU 610 may also reside on a single integrated circuit.

Preferred implementations of the invention include implementations as a computer system programmed to execute the method or methods described herein, and as a computer program product. According to the computer system implementation, sets of instructions for executing the method or methods are resident in the random access memory 614 of one or more computer systems configured generally as described above. These sets of instructions, in conjunction with system components that execute them may annotate uploaded graphics files with viewer recognizable annotations, as described hereinabove. Until required by the computer system, the set of instructions may be stored as a computer program product in another computer memory, for example, in disk drive 620 (which may include a removable memory such as an optical disk or floppy disk for eventual use in the disk drive 620). Further, the computer program product can also be stored at another computer and transmitted to the users work station by a network or by an external network such as the Internet. One skilled in the art would appreciate that the physical storage of the sets of instructions physically changes the medium upon which is the stored so that the medium carries computer readable information. The change may be electrical, magnetic, chemical, biological, or some other physical change. While it is convenient to describe the invention in terms of instructions, symbols, characters, or the like, the reader should remember that all of these in similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

Although the present invention and its advantages have been described in detail, it should be understood that various changes, substitutions and alterations can be made herein without departing from the spirit and scope of the invention as defined by the appended claims.

What is claimed:

1. A method of annotating a digital image comprising:
acquiring data representing a position corresponding to a locus of the digital image;
correlating descriptive information with the data representing the position; and
associating the descriptive information with a digital image file containing the digital image.

2. The method of claim 1 further including in response to user input, selectably associating the data representing the position with the digital image file containing the digital image.

3. The method of claim 1 wherein the step of correlating descriptive information comprises:
accessing a database comprising position data and associated descriptive information; and
retrieving descriptive information from an entry in the database associated with the position data matching the data representing the position corresponding to the locus of the digital image.

4. The method of claim 3 further comprising refining the position data representing a locus of the digital image in response values of one or more parameters associated with a recording device for generating the digital image.

5. The method of claim 4 wherein the parameters are selected from the group consisting of a compass direction, a tilt angle, and focal parameters, of an optical system of the recording device.

6. The method of claim 1 further comprising uploading the digital image file to a data processing system, wherein the data processing system is operable for correlating descriptive information with the data representing the position, and wherein the data representing the position is incorporated in the digital image file.

7. The method of claim 6 wherein correlating descriptive information comprises:
accessing a database comprising position data and associated descriptive information; and
retrieving descriptive information from an entry in the database associated with the position data matching the data representing the position corresponding to the locus of the digital image, and wherein the database is selected from the group consisting of a local database on the data processing system and a remote database accessed via a network connected to the data processing system.

8. A computer program product embodied in a tangible storage medium for annotating digital images comprising programming instructions for:
acquiring data representing a position corresponding to a locus of the digital image;
correlating descriptive information with the data representing the position; and
associating the descriptive information with a digital image file containing the digital image.

9. The program product of claim 8 further including programming for, in response to user input, selectably associating the data representing the position with the digital image file containing the digital image.

10. The program product of claim 8 wherein the programming instructions for correlating descriptive information comprise programming instructions for:
accessing a database comprising position data and associated descriptive information; and
retrieving descriptive information from an entry in the database associated with the position data matching the data representing the position corresponding to the locus of the digital image.

11. The program product of claim 10 further comprising programming instructions for refining the position data representing a locus of the digital image in response values of one or more parameters associated with a recording device for generating the digital image.

12. The program product of claim 11 wherein the parameters are selected from the group consisting of a compass direction, a tilt angle and focal point parameters of an optical system of the recording device.

13. The program product of claim 8 further comprising programming instructions for uploading the digital image file to a data processing system, wherein the data processing system is operable for correlating descriptive information with the data representing the position, and wherein the data representing the position is incorporated in the digital image file.

14. The program product of claim 13 wherein programming instructions for correlating descriptive information comprise programming instructions for:
accessing a database comprising position data and associated descriptive information; and
retrieving descriptive information from an entry in the database associated with the position data matching the data representing the position corresponding to the locus of the digital image, and wherein the database is selected from the group consisting of a local database on the data processing system and a remote database accessed via a network connected to the data processing system.

15. A system for annotating digital images comprising:
circuitry operable for acquiring data representing a position corresponding to a locus of the digital image;
circuitry operable for correlating descriptive information with the data representing the position; and
circuitry operable for associating the descriptive information with a digital image file containing the digital image.

16. The system of claim 15 further comprising:
circuitry operable for accessing a database comprising position data and associated descriptive information; and
circuitry operable for retrieving descriptive information from an entry in the database associated with the position data matching the data representing the position corresponding to the locus of the digital image.

17. The system of claim 16 further comprising circuitry operable for refining the position data representing a locus of the digital image in response values of one or more parameters associated with a recording device for generating the digital image.

18. The system of claim 17 further comprising components selected from the group consisting of a tilt sensor, an optical imaging system and an electronic compass, and wherein the parameters comprise one or more of a compass direction, a tilt angle and focal parameters of the optical imaging system.

19. The system of claim 15 further comprising circuitry operable for uploading the digital image file to a data processing system, wherein the data processing system is operable for correlating descriptive information with the data representing the position by:
accessing a database comprising position data and associated descriptive information; and
retrieving descriptive information from an entry in the database associated with the position data matching the data representing the position corresponding to the locus of the digital image, and wherein the database is selected from the group consisting of a local database on the data processing system and a remote database accessed via a network connected to the data processing system, the data representing the position being incorporated in the digital image file.

20. The system of claim 15 wherein the circuitry operable for acquiring data representing a position corresponding to a locus of the digital image, circuitry operable for correlating descriptive information with the data representing the position, and circuitry operable for associating the descriptive information with a digital image file containing the digital image comprises one or more of a microprocessor, a microcontroller, application specific integrated circuit and a programmable logic array.
